(19) United States
(12) Patent Application Publication
(10) Pub. No.: US 2013/0127245 A1
(43) Pub. Date: May 23, 2013

(54) POWER SUPPLY SYSTEM FOR ON BOARD HYDROGEN GAS SYSTEMS

(71) Applicant: Uli Kruger, Aldgate (AU)

(72) Inventor: Uli Kruger, Aldgate (AU)

(21) Appl. No.: 13/321,419

(22) Filed: Nov. 18, 2011

(51) Int. Cl. B60R 16/03

(52) U.S. Cl. CPC B60R 16/03
USPC 307/10.1

(57) ABSTRACT

Power supply systems for a vehicle comprise at least one current sensing device, and a regulatory microprocessor coupled to the at least one current sensing device. In some embodiments, contemplated power supply systems comprise at least one electronic pressure sensor. Contemplated electronic pressure systems may comprise a manifold absolute pressure sensor or MAP sensor. In other embodiments, contemplated systems comprise a maximum energy power limiter. Engine systems are also disclosed that include at least one battery or storage system, a power supply system, a hydrogen or hydrogen/oxygen gas generator, and an engine.

This application is a United States Utility application that is based on U.S. Provisional Patent Application Ser. No. 61/179,178 filed on May 18, 2009 and PCT Application Publication No.: WO 2010/135355 entitled “Power Supply System for On Board Hydrogen Gas Systems”, which are commonly-owned and incorporated herein in their entirety by reference.

### BACKGROUND

Alternative fuel-based vehicles, both existing cars and concept cars, have gained popularity in recent years as a result of rising gasoline cost, longer commute times, traffic congestion and increased public awareness on the consequences of green-house gas emissions and the use of foreign oil.

The reality of domestic crude oil drilling is that there is not enough equipment or refineries to process enough recovered crude oil to meet our immediate demands. Any crude recovered won't be ready for public consumption for at least eight years. Two other options that are being used to bridge the gap between foreign oil importation, domestic oil production and new technologies are ethanol and compressed natural gas. Both fuels solve the problem of America's dependence on foreign sources of oil. Neither fuel solves the problems of greenhouse gas emissions and complete renewable energy sources.

Ethanol is produced in the US from corn or switchgrass, as opposed to sugar ethanol produced in South America, and is utilized as both a fuel additive and straight fuel source. While ethanol fuel is cleaner than gasoline, the process to produce ethanol is rife with greenhouse gas-producing sources, including ethanol-generating facilities that burn coal to transform corn to ethanol.

Compressed natural gas (CNG) is a fossil fuel source and found in abundance in the US. While it is a cleaner combustion fuel, it still produces greenhouse gases. The innovation surrounding CNG will be directed primarily to four things: recovery of CNG, gas station retrofitting to accept CNG, since the tanks needed to store this fuel source are larger, retooling of transportation production lines to produce engines that can accept CNG, and scrubbing exhaust streams of greenhouse gases.

The “holy grail” in the area of automobile development is to give the consumer unlimited car options, while at the same time significantly improving fuel efficiency, moving to zero emission engines and travelling long distances without charging, if the car is electric. Car buyers do not want to be forced to purchase small cars with little/no storage space, power or hauling capacity.

Developers are also utilizing new sources of power generation, such as solar and turbines, to provide power to new engines. Obviously, both of these power sources are renewable and do not rely on complex processes for recovery, refinement and production. Key innovations in this particular technology will improve the efficiency and size of solar panels and components, along with similar advancements in turbine development. These innovations are already taking place with solar and wind turbine power generation on a large scale.

Once the power is generated and backup power is stored, the next step is giving the car enthusiast a reason to get excited about driving these new cars. Most of this excitement comes from the ability to move quickly with power over different terrains without loss of performance.

Technology has come far enough along to make the concept of an “ideal vehicle” a reality for the typical consumer. The ideal vehicle is powered by an unlimited renewable source, such as wind, waves or sun. In the case of wind and waves—each of these sources can be utilized to produce the electricity used to charge up a battery in a vehicle. An ideal vehicle is whatever type of vehicle that car buyer wants to purchase, as mentioned earlier. If the consumer wants to purchase a large SUV, such as a Suburban or Hummer, the car should be hybrid-electric or electric, powerful and have a long-range of travel between charges. These cars should also be zero emission vehicles that are capable of powering a home or other facility, if necessary, as opposed to being a one-way consumer of power and electricity.

As researchers continue to develop new and improved engines, there are several areas that are focused on: performance, efficiency and ease of use. Performance can be measured by how a vehicle—whether it's a car, motorcycle or boat—responds under a “request” by the driver for more power. Whether a driver wants to accelerate quickly or tackle an incline at consistent speeds, performance is an important consideration when building and/or improving engines. Efficiency is related to performance, and is measured by how much of the stored energy is converted into kinetic energy and how much of it is lost as heat. Finally, the ease of use relates to whether the engine and related devices are easy to manufacture, easy to install and easy to maintain by a consumer. All of these component characteristics should be considered and balanced when designing, developing and building new engine technologies.

Hydrogen fuel systems are under development as an alternative to gasoline and ethanol systems, because they can generate dynamic fuel from water and similar fluids. When operating an electrolysis-based hydrogen fuel system in a motor vehicle, the amount of hydrogen produced is generally relative to the current consumption of the electrolyser, which is determined by a number of factors: anode/cathode surface area, electrolyte concentration, electrolyte temperature and applied input voltage.

The electrolyte temperature, in particular, has a significant effect on the current draw with increases of up to 100% as the solution/fluid warms. The electrolyte concentration will also change between water refill cycles, as only the water but not the electrolyte is consumed in the process. In other words, at low water reservoir level, the electrolyte concentration will therefore be higher than at high levels.

The required amount of hydrogen/oxygen gas may vary in response to the applied engine load factor. When diesel fuel is substituted with a predetermined amount of hydrogen at the correct input rate relative to engine load, the resultant total engine power output will be higher than original levels, which may not always be desirable, since an increased power output may have adverse effects on engine and drive-train durability. Engine and drive-train durability is especially important in the heavy transport sector where equipment is traditionally operated at average duty cycles above 50%.

Therefore, it would be ideal to develop a system that will easily and reliably regulate the effective average output current in a variety of engine configurations and environments.

### SUMMARY

Power supply systems for a vehicle include at least one current sensing device, and a regulatory microprocessor coupled to the at least one current sensing device. In some embodiments, power supply systems disclosed include at least one electronic pressure sensor. Contemplated electronic pressure systems may include a manifold absolute pressure sensor or MAP sensor. In other embodiments, contemplated systems include a maximum energy power limiter.

Engine systems are also disclosed that include at least one battery or storage system, a power supply system, a hydrogen or hydrogen/oxygen gas generator, and an engine.

### BRIEF DESCRIPTION OF THE FIGURES

FIG. 1 shows a schematic of an engine system comprising a contemplated power supply system.

FIG. 2 shows a schematic of a contemplated power supply system.

### DETAILED DESCRIPTION

In order to meet the goals disclosed herein, a power supply system has been developed where the effective average output current is regulated as a percentage of the duty cycle value of a square wave form in reference to the peak input current value.

Specifically, contemplated power supply systems for a vehicle comprise at least one current sensing device, and a regulatory microprocessor coupled to the at least one current sensing device. In some embodiments, contemplated power supply systems comprise at least one electronic pressure sensor. Contemplated electronic pressure systems may comprise a manifold absolute pressure sensor or MAP sensor. In other embodiments, contemplated systems comprise a maximum energy power limiter. As used herein, the term “coupled” as used herein with respect to the regulatory microprocessor means that the regulatory microprocessor may be directly connected to the at least one current sensing device or may be indirectly connected to the at least one current sensing device through a series of other devices or switches.

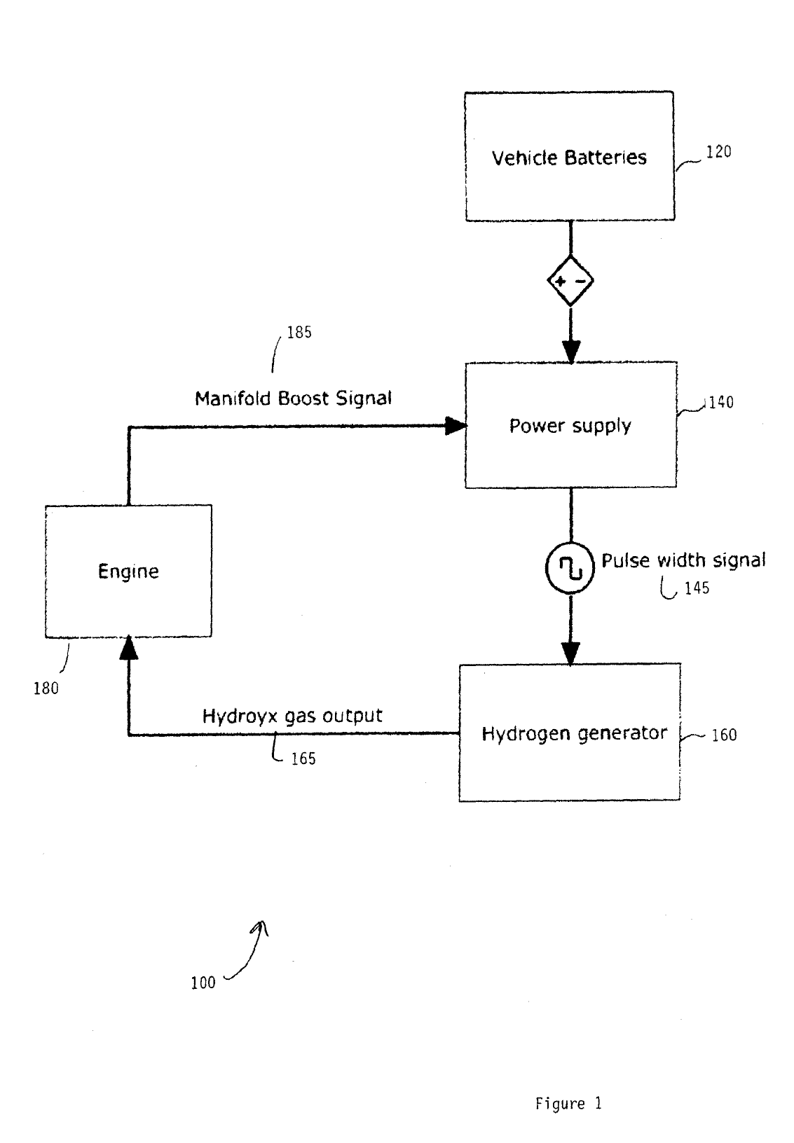

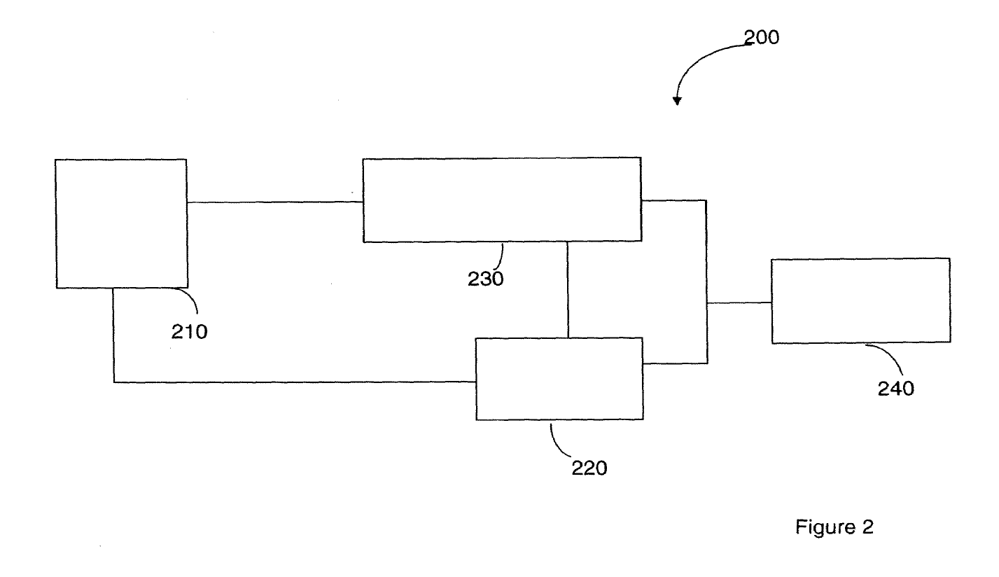

In some embodiments, a contemplated engine system 100, which is shown in FIG. 1 and incorporates a contemplated power supply system 140, comprises at least one vehicle battery or storage system 120, a power supply system 140 that provides a pulse width signal 145 to the hydrogen or hydrogen/oxygen gas generator 160, a hydrogen or hydrogen/oxygen gas generator 160 that provides hydrogen or hydrogen/oxygen (hydroyx) gas output 165 and an engine 180 that provides a manifold boost signal 185 back to the power supply 140. A contemplated power supply system 200 is shown in FIG. 2.

Contemplated vehicle batteries or storage systems may comprise any suitable battery and/or storage system arrangement. In some contemplated embodiments, a storage system comprises that system found in U.S. patent application Ser. No. 12/638,752, which is commonly owned and incorporated herein in its entirety.

As mentioned and shown in FIG. 2, contemplated power supply systems 200 for a vehicle (not shown) comprise at least one current sensing device 210, and a regulatory microprocessor 220 coupled to the at least one current sensing device 210 and a power supply 230. Contemplated power supply systems also comprise at least one Hall Effect current sensing device on the input side of the power supply system. In contemplated embodiments, the effective current acting upon the electrolytic cell is regulated by reducing the pulse width cycle of a DC square waveform in reference to a preset maximum average output current value. Contemplated microprocessors 220 are designed to access, store, manipulate and distribute data.

Contemplated power supply systems may also incorporate at least one electronic pressure sensor 240. As mentioned earlier, contemplated electronic pressure systems may comprise a manifold absolute pressure sensor or MAP sensor. In some embodiments, MAP sensors comprise at least one turbo boost MAP sensor.

As an example of how a contemplated system would operate, contemplated microprocessors can store the maximum engine turbo boost pressure value. Contemplated maximum engine turbo boost values are maintained at the previously stored value when the engine is substituted with hydrogen and/or hydrogen/oxygen gas, as opposed to another fuel source. In some embodiments, a contemplated maximum engine turbo boost is prevented from exceeding a previously stored value by regulating the output value of the vehicle throttle position sensor through a microprocessor controlled digital potentiometer.

Contemplated microprocessors also regulate the average current output by calculating the duty cycle percentage of the output square wave from the desired output current value in reference to the measured peak input current value.

In some embodiments, a contemplated power supply system calculates the effective average output current in reference to a plurality of engine load points. In these embodiments, the engine load points are determined as manifold boost pressure values in a turbo charged diesel engine. In other embodiments, contemplated engine load points are determined as fuel injector duty cycle values in a normally aspirated gasoline or ethanol engine.

Contemplated maximum engine power limiters comprise an interface between the microprocessor, the throttle position sensor and the turbo boost MAP sensor. The given power output can be derived from the MAP sensor output value in reference to a given throttle position input value. The maximum achievable value under normal “diesel-only” operating conditions is stored in the memory of the microprocessor, which can be achieved in contemplated embodiments by running a contemplated power supply system in learning mode while running the engine up to full load, either on a chassis dynamometer or on the road. In other embodiments where baseline operating conditions have already been established, the power supply system can be pre-programmed.

Upon activation of the hydrogen system, contemplated power supply systems will switch into “run” mode. As soon as the measured MAP sensor value in reference to the TPS output value begins to exceed the previous maximum stored value, the microprocessor ramps back the TPS output via a digital potentiometer, thereby maintaining the original power output level.

Contemplated power supply systems and related devices also may comprise menu selection buttons as well as an LCD display panel, allowing the user to pre-program the desired average output current in reference to a plurality of engine load points. The load points are represented as manifold pressure values. It should be understood; however, that contemplated supplies and devices may comprise any suitable control mechanisms that function to pre-program or program the desired average output current. In some embodiments, it may be desirable to be able to remotely program the desired average output current from another location, and this programming step would then be accomplished by utilizing a wireless two-way communication connection. In some embodiments, contemplated power supply systems may be monitored and/or controlled by utilizing the Intelligent Vehicle Dashboard, which is disclosed and described in U.S. Provisional Application Ser. No. 61/108,135, which is commonly-owned and incorporated herein in it's entirety by reference.

Contemplated systems can be utilized in any system that currently utilizes any of the following engine systems: a gasoline internal combustion engine, a diesel engine, a bio-diesel engine, a turbine engine, a Wankel rotary engine, a Bourke engine, an ECTAN engine, an engine that uses E85 fuel, a flexible-fuel engine (an engine that operate on either gasoline or E85 fuel), an ethanol powered engine, a natural-gas powered engine, a jet-fuel turbine engine, a modified diesel engine using vegetable oil as a fuel, a steam engine or a combination thereof. Contemplated systems can also be utilized in those vehicles described in U.S. patent application Ser. No. 12/370,380 or U.S. Provisional Application Ser. No. 61/122,531, which is commonly-owned and incorporated herein in their entirety by reference.

Contemplated vehicles may also comprise a regenerative braking system. The regenerative braking system connects to the brakes on the front wheels or another part of the vehicle that facilitates movement, such as a rotor, and works to charge the back-up battery/battery pack.

Contemplated vehicles may comprise any suitable vehicle, such as a car, boat, motorcycle, jet ski, truck or another vehicle. The vehicle may further comprise a battery pack, a generator and/or a modified gear box. Some contemplated embodiments may also comprise an overall motor controller or controller that regulates the various components of the vehicle. The vehicle may also comprise other components commonly found in an electric or hybrid vehicle.

Thus, specific embodiments, power supply systems for on-board hydrogen gas systems have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A power supply system for a vehicle, comprising:
at least one current sensing device, and
a regulatory microprocessor coupled to the at least one current sensing device.

2. The power supply system of claim 1, further comprising at least one electronic pressure sensor.

3. The power supply system of claim 2, wherein the at least one electronic pressure sensor comprises a manifold absolute pressure sensor.

4. The power supply system of claim 3, wherein the manifold absolute pressure sensor is a turbo boost manifold absolute pressure sensor.

5. The power supply system of claim 1, further comprising a maximum energy power limiter.

6. The power supply system of claim 1, wherein the maximum energy power limiter comprises an interface between the regulatory microprocessor, a throttle position sensor and a turbo boost manifold absolute pressure (MAP) sensor.

7. The power supply system of claim 1, wherein the system is utilized with an onboard hydrogen gas system.

8. The power supply system of claim 1, wherein the power supply system is pre-programmed using the regulatory microprocessor.

9. The power supply system of claim 1, wherein the system comprises at least one menu selection button, at least one LCD display panel or a combination thereof.

10. The power supply system of claim 1, wherein the power supply system is pre-programmed using the regulatory microprocessor, an intelligent vehicle dashboard or a combination thereof.

11. An engine system, comprising:
at least one battery or storage system,
a power supply system,
a hydrogen or hydrogen/oxygen gas generator, and
an engine.

12. The engine system of claim 11, wherein the power supply system is the system of claim 1.

13. The engine system of claim 11, wherein the engine comprises a gasoline internal combustion engine, a diesel engine, a bio-diesel engine, a turbine engine, a Wankel rotary engine, a Bourke engine, an ECTAN engine, an engine that uses E85 fuel, a flexible-fuel engine (an engine that operate on either gasoline or E85 fuel), an ethanol powered engine, a natural-gas powered engine, a jet-fuel turbine engine, a modified diesel engine using vegetable oil as a fuel, a steam engine or a combination thereof.

14. The engine system of claim 11, wherein the power supply system comprises at least one current sensing device and a regulatory microprocessor coupled to the at least one current sensing device.

15. The power supply system of claim 14, further comprising at least one electronic pressure sensor.

16. The power supply system of claim 15, wherein the at least one electronic pressure sensor comprises a manifold absolute pressure sensor.

17. The power supply system of claim 16, wherein the manifold absolute pressure sensor is a turbo boost manifold absolute pressure sensor.

18. The power supply system of claim 11, further comprising a maximum energy power limiter.

19. The power supply system of claim 11, wherein the maximum energy power limiter comprises an interface between the regulatory microprocessor, a throttle position sensor and a turbo boost manifold absolute pressure (MAP) sensor.

20. The power supply system of claim 11, wherein the system is utilized with an onboard hydrogen gas system.

21. The power supply system of claim 11, wherein the power supply system is pre-programmed using the regulatory microprocessor, an intelligent vehicle dashboard or a combination thereof.
